(19) United States
(12) Patent Application Publication
(10) Pub. No.: US 2013/0077564 A1
(43) Pub. Date: Mar. 28, 2013

(54) METHOD AND APPARATUS FOR PROVIDING A WIRELESS PACKET CABLE ENDPOINT

(71) Applicant: Somendra Nath Tiwari, Bangalore (IN)

(72) Inventor: Somendra Nath Tiwari, Bangalore (IN)

(73) Assignee: GENERAL INSTRUMENT CORPORATION, Horsham, PA (US)

(21) Appl. No.: 13/240,665

(22) Filed: Sep. 22, 2011

(51) Int. Cl. H04W 4/00

(52) U.S. Cl. 370/328

(57) ABSTRACT

Methods and apparatuses for recognizing a short range wireless protocol enabled device as a packet-cable endpoint are disclosed. A gateway can provide existing and enhanced services to an end-user over a short range wireless protocol network. A user will have a flexible option to use packet-cable services over any short range wireless protocol enabled user equipment. The user equipment, acting as a packet-cable endpoint, works as a phone or fax machine, providing packet-cable services over a short range wireless protocol connection.

### BACKGROUND

In current packet cable network systems, voice and fax service is provided over RJ11 ports. As such, analog phones and fax machines are required in order to use the service. FIG. 1 illustrates a prior art packet cable system 100. Gateway 115 is coupled to Packet Cable Network 105 via Hybrid Fiber Coax link 110. Gateway 115 is a Wi-Fi enabled device. Gateway 115 is coupled to telephone 120 and fax machine 125 via RJ11 ports 130 and 135, respectively. Current cable gateways have Wi-Fi support for Wireless Local Area Network (WLAN). As previously stated, current gateways provide packet-cable services over RJ11 ports. Voice call service is currently provided over an RJ11 port using Session Initiation Protocol (SIP) or Network-based Call Signaling (NCS) protocols. An analog phone is required to make or receive voice calls. FAX/Voice Band Data Service, where a user can send fax or voice band data, is provided using fax machines or analog modems to another user connecting via a telephony RJ11 port. WLAN capability is also provided for using data services over Wi-Fi.

Currently, there is no support for providing Voice/Fax services via the gateway over Wi-Fi. The present disclosure addresses this shortcoming in the prior art.

### SUMMARY

A method for providing a short range wireless protocol packet-cable endpoint using a gateway is disclosed. A request to establish a short range wireless protocol network connection between the gateway and a user entity is received. A client application connection request is received from the user entity via the short range wireless protocol connection. The user entity is recognized as a packet-cable endpoint in response to the received client application connection request. Once the user entity is recognized as a packet-cable endpoint, packet-cable data traffic is able to be sent and received via the short range wireless protocol connection.

The gateway may periodically perform a status check for available user entities. The gateway receives status update messages from the user entity. The packet-cable data traffic may be marked for identification as packet-cable data.

In one embodiment, the gateway sends an alarm trigger to the user entity in response to a detected event. In one embodiment, the traffic for the connection is marked or shaped for quality of service (QoS).

A method for providing a short range wireless protocol packet-cable endpoint using a user entity is disclosed. A request to establish a short range wireless protocol network connection between a gateway and the user entity is sent. A client application connection request is sent to the gateway via the short range wireless protocol connection. In response to being recognized by the gateway as a packet-cable endpoint, packet-cable data traffic is sent and received via the short range wireless protocol connection.

Traffic may be marked for identification as packet-cable data in a short range wireless protocol frame. Status check messages may be received from the gateway. Status update messages may be sent to the gateway. An alarm trigger may be received from the gateway in response to an event detected by the gateway. Traffic for the connection can be marked or shaped for Quality of Service (QoS).

A gateway for providing a short range wireless protocol packet-cable endpoint is disclosed. A receiver receives a request from a user entity to establish a short range wireless protocol connection between the gateway and the user entity. The receiver receives a client application connection request from the user entity via the short range wireless protocol connection. A processor recognizes the user entity as a packet-cable endpoint in response to the received client application connection request.

The gateway receives status update messages from the user entity. The traffic may be marked for identification as packet-cable data. The gateway uses a transmitter to send an alarm trigger to the user entity in response to a detected event.

A user entity for providing a short range wireless protocol packet-cable endpoint is disclosed. A processor uses a receiver to detect a short range wireless protocol signal provided by a gateway. A transmitter sends a request to establish a packet-cable short range wireless protocol network connection between a gateway and the user entity. The transmitter sends a client application connection request to the gateway via the short range wireless protocol connection. The transmitter and the receiver are configured to respectively send and receive packet-cable data via the short range wireless protocol connection.

The receiver may receive status check messages from the gateway. The transmitter may send status update messages to the gateway. The receiver may receive an alarm trigger from the gateway in response to an event detected by the gateway.

### BRIEF DESCRIPTION OF THE DRAWINGS

So that the manner in which the above recited features of the present disclosure are attained and can be understood in detail, a more particular description of the disclosure, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 illustrates a prior art packet cable system 100;

FIG. 2 illustrates an exemplary packet cable system 200;

FIG. 3 illustrates an exemplary Wi-Fi protocol frame format 300;

FIG. 4 illustrates a method 400 for providing a Wi-Fi packet-cable endpoint using a gateway, according to one embodiment;

FIG. 5 illustrates a method 500 for providing a Wi-Fi packet-cable endpoint using a user entity, according to one embodiment;

FIG. 6 illustrates a method 600 for providing an alarm according to one embodiment;

FIG. 7 illustrates a method 700 for providing an alarm according to one embodiment;

FIG. 8 illustrates a method 800 for handling a phone call at a gateway that has recognized a user entity as a packet-cable endpoint, according to one embodiment;

FIG. 9 illustrates a method 900 for handling an incoming call at a user entity, according to one embodiment;

FIG. 10 illustrates a method 1000 of managing packet-cable endpoints according to one embodiment; and

FIG. 11 illustrates a block diagram of an example device 1100 according to one embodiment.

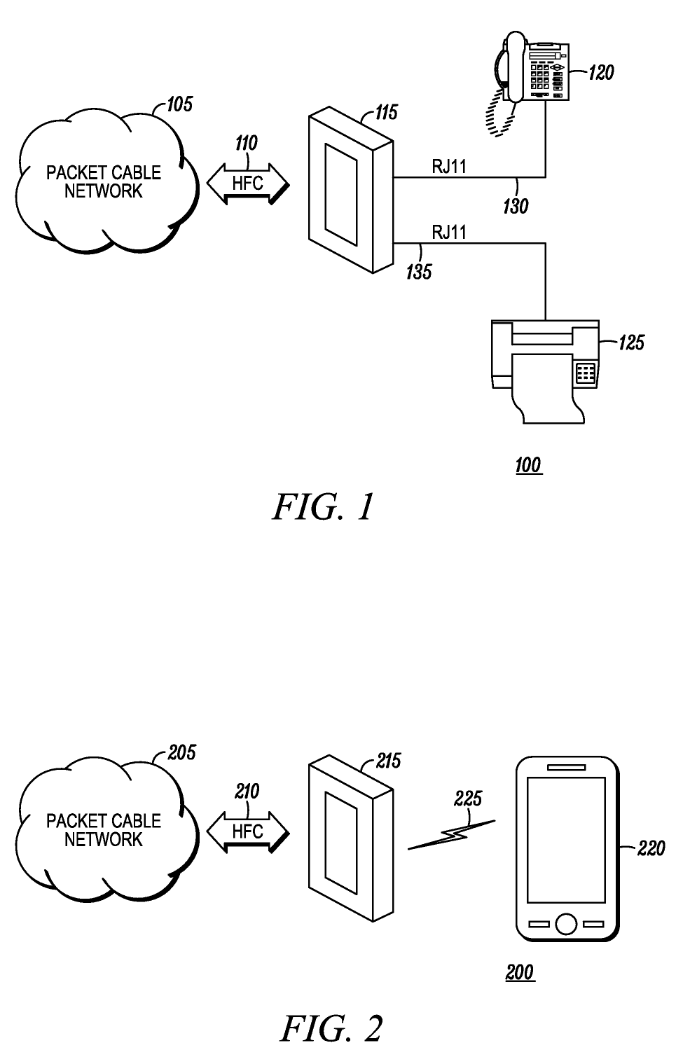

### DETAILED DESCRIPTION

The present disclosure describes methods and apparatuses for providing a packet-cable endpoint over a short range wireless protocol network connection. The short range wireless protocol may be any wireless local area network (LAN) or personal area network (PAN). One example of a PAN is Bluetooth. However, for clarity of the disclosure, the description below references the Wi-Fi standard as the short range wireless protocol since present gateways already have Wi-Fi hardware/driver software support and the Wi-Fi standard allows Wi-Fi enabled devices (e.g. gateway, user entity) to operate at a considerably greater distance/range (e.g. approximately 60 meters) from each other. In addition, Wi-Fi offers new antenna technologies like MIMO (multiple-input and multiple output), which covers a longer range with better quality.

FIG. 2 illustrates an exemplary packet cable system 200. Gateway 215 is coupled to Packet Cable Network 205 via Hybrid Fiber Coax link 210. Gateway 215 may be a Wi-Fi enabled device. Gateway 215 is coupled to user equipment 220 over short range wireless protocol link 225. In one embodiment, short range wireless protocol link 225 is a Wi-Fi link. Current cable gateways have Wi-Fi support for Wireless Local Area Network (WLAN). An embedded multimedia terminal adapter (EMTA) of gateway 205 recognizes a Wi-Fi enabled device, e.g. user equipment 220, as a packet-cable endpoint. EMTA 205 can provide existing and enhanced services to an end user of portable multimedia device 220 over Wi-Fi. A user has the flexible option of using existing and enhanced services over any Wi-Fi enabled user equipment. User equipment 220 may be a mobile device, e.g., a laptop, netbook, tablet, portable multimedia device, wireless phone, smart phone. User equipment 220 may also be a Wi-Fi enabled fax machine. User equipment 220 may work as a phone or fax machine providing packet-cable services to a user. In addition, user entity may also make video calls as a packet-cable endpoint. Video calls can be part of enhanced services provided by user equipment 220 since user equipment 220 may have a camera and other hardware that enables a user to use a video call service over the packet-cable network.

The Wi-Fi multimedia (WMM) or Wireless Multimedia Extensions (WME) standard provides Quality of Service (QoS) capabilities over Wi-Fi connectivity. EMTA 205 uses WMM or WME to provide packet-cable QoS for voice services to a Wi-Fi endpoint, e.g. user equipment 220.

User equipment 220 has client software installed that enables packet-cable services over Wi-Fi. User equipment 220 is able to detect a Wi-Fi signal, e.g. link, provided by gateway 215. In one embodiment, a client, e.g. user equipment (UE) 220, connects to gateway 215 over Wi-Fi link 225. Gateway 215 recognizes UE 220 as a normal packet-cable endpoint. Once recognized by gateway 215 as a packet-cable endpoint, all services available to a normal packet-cable endpoint are made available to UE 220.

UE client software, e.g. a client application, required to use packet-cable services over Wi-Fi may be provisioned in a variety of ways. In one embodiment, client software is downloaded from UE manufacturer or network operator websites. In one embodiment, client software is pre-installed on UE 220.

In one embodiment, client software is downloaded from gateway 215. A user can connect to gateway 215 and download client software from a link provided in a management page provided by the gateway. Software can be hosted on gateway 215 or on the web. When software is hosted on the web, the link provided by the management page points to a location from which the client software application may be downloaded.

Once client software has been installed on UE 220, UE 220 is configured so that gateway 215 is able to recognize UE 220 as a packet-cable endpoint. All gateways have management mechanisms that are accessible via a graphical user interface (GUI). A user may logon to the management page of gateway 215 in order to configure UE 220 with gateway 215. This configuration can be modified when needed. Configuration parameters may include: 1) A (MAC) address of the UE when a user desires to restrict packet-cable services to certain UEs; 2) a user name/password to be used on the UE for the packet-cable service; 3) Certificates or authentication mechanism to be used by the UE; 4) Service features like line numbers and service/call redirection options (e.g. whether the UE has a completely separate number or the main number associated with the packet-cable service. The above configuration parameters may have default values, operator set options, or custom options. Once UE 220 is configured as a packet-cable endpoint on the management interface of gateway 215, all traffic coming from UE 220 associated with UE packet-cable endpoint software will be treated as end-point traffic/messages.

Gateway 215 has software installed in order to recognize a UE as a packet-cable endpoint over a Wi-Fi connection. Gateway software may be pre-installed on gateway 215. Gateway software may also be downloaded via packet cable network 205. Once gateway 215 is properly configured to recognize UE 220 as a packet-cable endpoint, gateway 215 may redirect services traffic to UE 220 and perform other actions in furtherance of maintaining UE 220 as a packet-cable endpoint.

Once a Wi-Fi connection is established between gateway 215 and UE 220, the client application on UE 220 sends a client application connection request to gateway 215 via Wi-Fi connection 225. The client application connection request is sent in packets to gateway 215 via Wi-Fi connection 225. The packets are marked for identification as packet-cable data. Gateway 215 will recognize UE 220 as a packet-cable endpoint after the client application from UE 220 successfully establishes a Wi-Fi connection with gateway 215 and gateway 215 receives client application marked packet(s) from UE 220 after the Wi-Fi connection request. All other connection requests, other than the client application connection request, are treated as a normal Wi-Fi connection request. As stated previously, the client application can be configured by gateway 215, e.g. via user entity 220. The client application marks the Wi-Fi packet for appropriate identification, priority, and service class. Gateway 215, which serves as an access point for UE 220, uses the prioritizing mechanism in addition to the identification parameter used by both gateway 215 and the client application of UE 220 in order to handle packet-cable traffic over Wi-Fi connection 225.

In one embodiment, gateway 215 may check the status of UE 220 (e.g. whether the UE is available and in the vicinity of the Wi-Fi network). Gateway 215 may periodically check the available UEs (with the UE Client application) in the vicinity over Wi-Fi. Gateway 215 may also update a status of UE 220 in response to periodic messages received from UE 220. Packets and/or traffic carrying status messages from UE 220 to gateway 215 are marked for identification purposes.

In one embodiment, gateway 215 marks or shapes Wi-Fi traffic (including packet-cable endpoint traffic) for QoS in both an upstream and a downstream direction of UE 220. In one embodiment, gateway 215 triggers an alarm on UE 220 when UE 220 is going out of range. In one embodiment, the alarm is triggered when UE 220 is going out of range of the Wi-Fi connection with gateway 215 during a call.

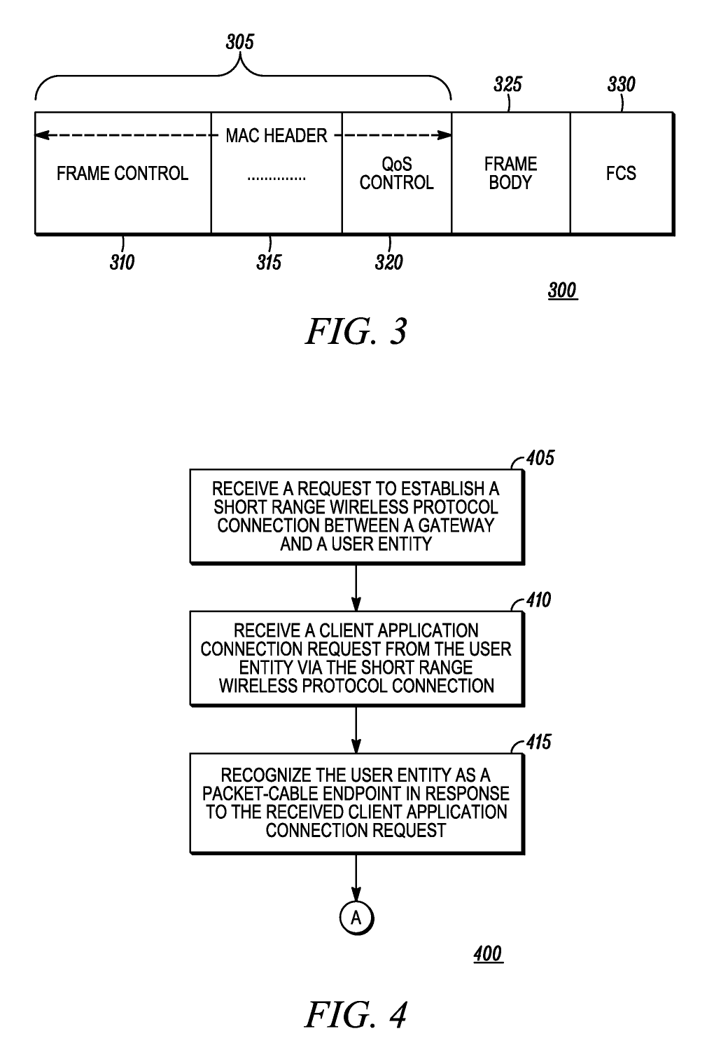

FIG. 3 illustrates an exemplary Wi-Fi protocol frame format 300. Packet-cable data is transmitted as a Wi-Fi Data packet portion, with appropriate Media Access Control (MAC) header markings to provide QoS/service class. MAC header 305 has frame control data 310, QoS control data 320, and other data 315. Frame body 325 is the actual portion where upper layer data is carried. Packet-cable data is inserted in the frame body 325 portion of a Wi-Fi Data packet. Control data and related QoS control data related to the packet-cable data are transported, respectively, in the frame control 310 and Qos control 320 parts of the Wi-Fi Data packet. Frame check sequence (FCS) 330 includes extra checksum characters that are added to the Wi-Fi protocol frame for error detection and correction.

Once gateway 215 recognizes user entity 220 as a packet-cable endpoint, user entity 220 is able to handle packet-cable services traffic. Thus, user entity 220 is able to make and receive phone calls and/or send and receive faxes. Gateway 215 will support calls and faxes as is normally handled in the existing mechanism, however there is a configurable option on the GUI for gateway 215 that allows the user to select whether calls/faxes should be made from the gateway, the UE endpoint software (client application), or both. The user may also select which account, e.g. telephone number, is to be associated with the call/fax. In one embodiment, the user can configure the same account for both the UE endpoint and the gateway and make a call or send a fax from the UE endpoint or the gateway via analog devices 120, 125. In one embodiment, when the UE is used to make and receive calls, the UE having endpoint software will provide the dialing and receiving mechanism.

In one embodiment, both gateway 215 (with associated analog device 120) and UE 220 may be configured to receive an incoming call. When UE 220 has been recognized as a packet-cable endpoint, and an incoming call has been detected by gateway 215, the gateway may cause both analog device 120 and UE 220 to ring. When a particular phone, e.g. UE 220, has picked up the incoming call, the other device, e.g. phone 120, may be left idle.

FIG. 4 illustrates a method 400 for providing a Wi-Fi packet-cable endpoint using a gateway, e.g. gateway 215, according to one embodiment. At step 405, a request to establish a short range wireless protocol, e.g. Wi-Fi, connection 225, between a gateway and a user entity is received, e.g. from user entity 220. At step 410, a client application connection request is received from the user entity via the short range wireless protocol connection. Once the short range wireless protocol connection is established between gateway 215 and UE 220, a client application connection request is received at gateway 215 from UE 220 via short range wireless protocol connection 225. The received client application connection request is included in one or more packets to gateway 215 marked by UE 220 for identification as packet-cable data via short range wireless protocol connection 225. All other connection requests, other than the client application connection request, are treated as normal short range wireless protocol, e.g. Wi-Fi, connection requests.

At step 415, the user entity is recognized as a packet-cable endpoint in response to the received client application connection request. Once the user entity is recognized as a packet-cable endpoint, packet-cable data traffic is sent and received via the short range wireless protocol connection. Gateway 215 receives short range wireless protocol packets, e.g. Wi-Fi packets, marked by UE 220 for appropriate identification, priority, and service class. Gateway 215, which serves as an access point for UE 220, uses the prioritizing mechanism in addition to the identification parameter used by both gateway 215 and client application of UE 220 in order to handle packet-cable traffic over Wi-Fi connection 225. In one embodiment, gateway 215 marks or shapes Wi-Fi traffic (including packet-cable endpoint traffic) for QoS in both an upstream and a downstream direction of UE 220.

In one embodiment, gateway 215 may check the status of UE 220. Gateway 215 may periodically check available UEs (with the UE Client application) in the vicinity of Wi-Fi connection 225. Gateway 215 may also update a status of UE 220 in response to periodic messages received from UE 220. In one embodiment, gateway 215 triggers an alarm on UE 220 when UE 220 is going out of range of Wi-Fi connection 225. In one embodiment, the alarm is triggered when UE 220 is going out of range of the Wi-Fi connection with gateway 215 during a call.

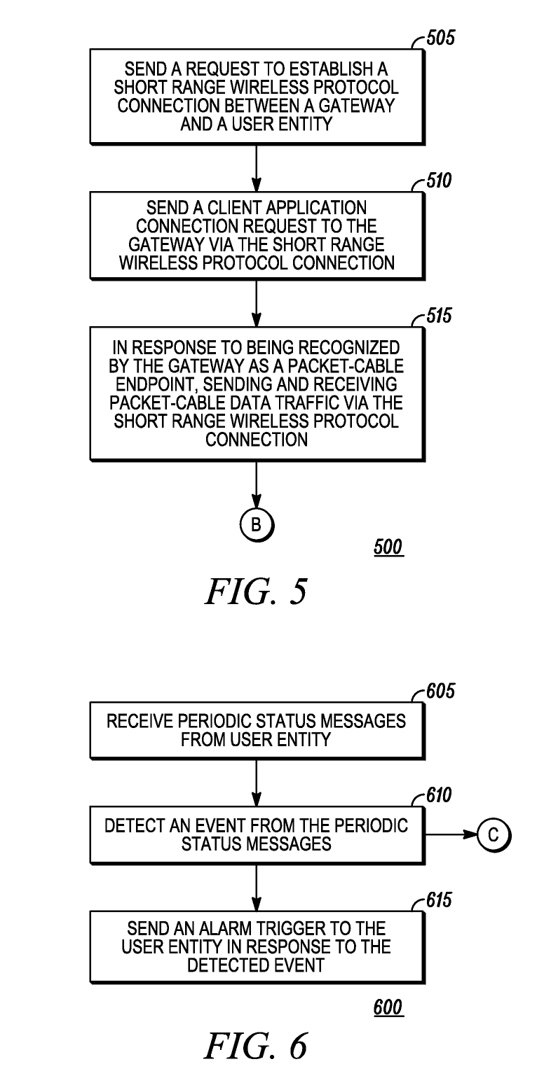

FIG. 5 illustrates a method 500 for providing a Wi-Fi packet-cable endpoint using a user entity, e.g. user entity 220, according to one embodiment. A user entity detects a short range wireless protocol connection, e.g. a Wi-Fi connection, provided by gateway 215. At step 505, a request to establish a short range wireless protocol connection, e.g. Wi-Fi connection 225, between a gateway and a user entity is sent to the gateway, e.g. gateway 215. At step 510, a client application connection request is sent to the gateway via the short range wireless protocol connection. Once the short range wireless protocol connection is established between gateway 215 and UE 220, the client application on UE 220 sends a client application connection request to gateway 215 via short range wireless protocol, e.g. Wi-Fi, connection 225. The client application connection request is sent in packets to gateway 215 via Wi-Fi connection 225. The packets are marked for identification as packet-cable data. At step 515, packet-cable data traffic is sent and received via the short range wireless protocol connection once the gateway has recognized the user entity as a packet-cable endpoint. The client application of UE 220 marks Wi-Fi packets for appropriate identification, priority, and service class. In one embodiment, periodic status check messages are received from gateway 215. In one embodiment, UE 220 sends periodic messages to gateway 215. In one embodiment, these periodic messages are status messages.

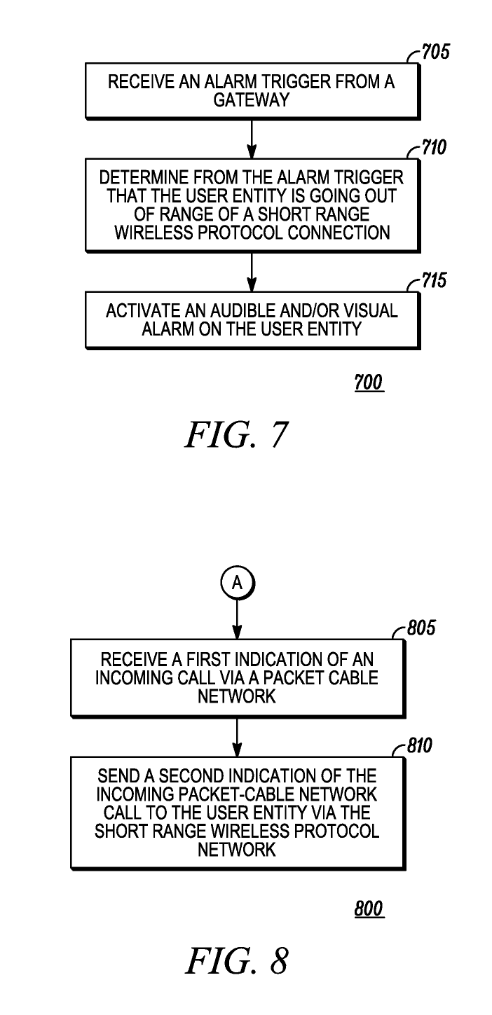

FIG. 6 and FIG. 7 illustrate methods 600 and 700 for providing an alarm according to one embodiment. At step 605, periodic status messages are received from a user entity that is recognized as a packet-cable endpoint and is on a call. At step 610, gateway 215 detects an event from periodic status messages received from UE 220. In one embodiment, the detected event is a determination from the periodic status messages received from UE 220 that UE 220 is going out of range of short range wireless protocol connection 225. In one embodiment, short range wireless protocol connection 225 is a Wi-Fi connection. At step 615, in response to the detected event, e.g. the determination that UE 220 is going out of range, gateway 215 sends an alarm trigger to UE 220. Moving on to FIG. 7, at step 705, UE 220 receives the alarm trigger, e.g. alarm message, from gateway 215. At step 710, the client application of UE 220 determines from the alarm trigger that the user entity is going out of range of short range wireless protocol connection 225. In one embodiment, short range wireless protocol connection 225 is a Wi-Fi connection. At step 715, in response to the alarm trigger, UE 220 activates an audible and/or visual alarm via a speaker and/or display of UE 220.

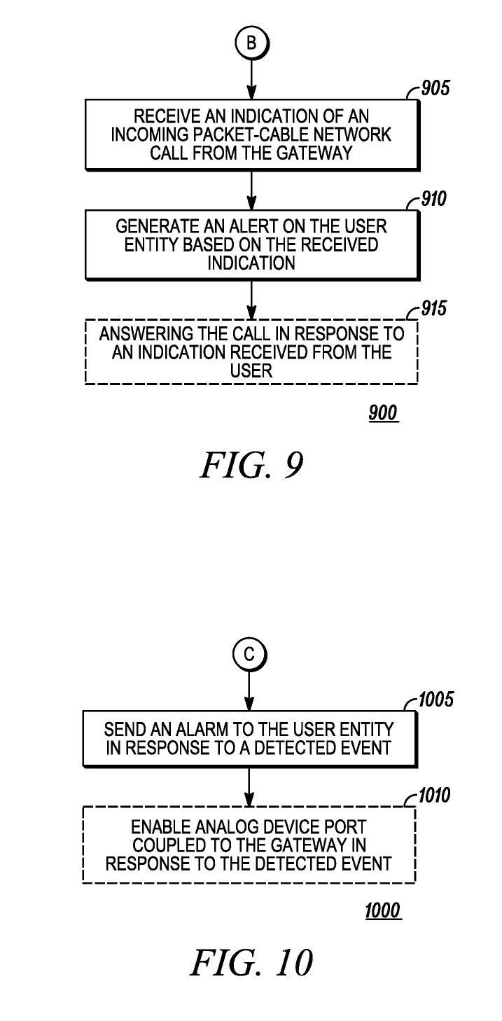

One embodiment of a use case enabled by the present disclosure is presented below. A user has a smart phone with Wi-Fi connectivity. The user also has a packet-cable telephony product at home. A telephone connected to a gateway is located in a corner of the user's house. When the user reaches his or her house, the user's smartphone connects to the gateway over Wi-Fi. The gateway recognizes the user's smart phone as a packet-cable endpoint. FIG. 8 illustrates a method 800 for handling a phone call at a gateway that has recognized a user entity as a packet-cable endpoint, according to one embodiment. At step 805, a first indication of an incoming call is received via the packet-cable network by the gateway. At step 810, a second indication of the incoming packet-cable network call is sent to the user entity via the short range wireless protocol network. FIG. 9 illustrates a method 900 for handling an incoming call at a user entity, according to one embodiment. At step 905, an indication of an incoming packet-cable network call is received from the gateway. At step 910, an alert is generated on the user entity based on the received indication. At step 915, the call may be optionally answered in response to an indication received via user input.

Another embodiment of a use case enabled by the present disclosure is described below. When a user leaves his or her house, e.g. leaves the boundaries of the short range wireless protocol network, the gateway recognizes that the Wi-Fi packet-cable endpoint has moved out of the range of the gateway. When the gateway detects an event, e.g. that the packet-cable endpoint has moved out of the range of the gateway, the gateway may enable an RJ11 port (having a connected analog telephone) as an active endpoint. FIG. 10 illustrates a method 1000 of managing packet-cable endpoints according to one embodiment. At step 1005, an alarm is sent to a user entity in response to a detected event. At step 1010, an analog device port coupled to the gateway is optionally enabled in response to the detected event.

The processes described above, including but not limited to those presented in connection with FIGS. 4-10, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium, e.g., a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

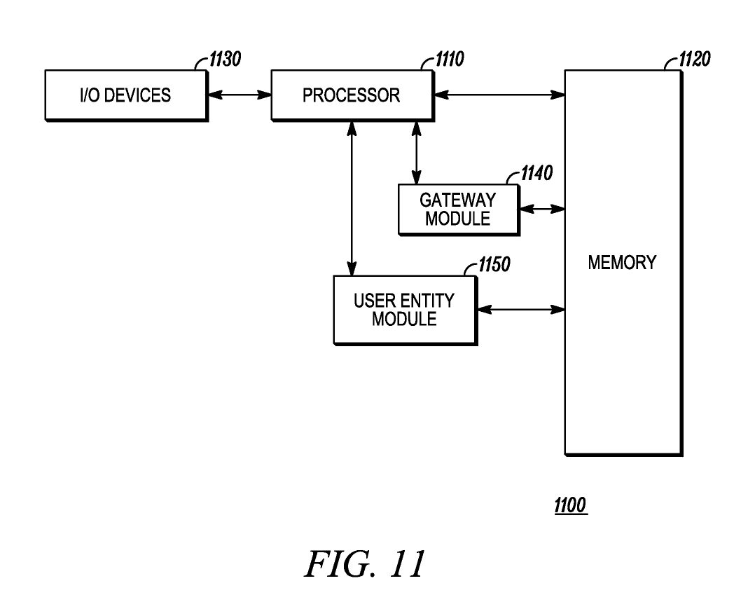

FIG. 11 illustrates a block diagram of an example device 1100. Specifically, device 1100 can be employed to provide a short range wireless protocol packet-cable endpoint. In one embodiment, the short range wireless protocol is Wi-Fi. Device 1100 may be implemented in gateway 215 in order to recognize a user entity as a packet cable endpoint with module 1140. Device 1100 may also be implemented in user entity 220 in order to allow a user entity to be recognized as a packet-cable endpoint and send/receive packet-cable endpoint traffic with module 1150.

Device 1100 comprises a processor (CPU) 1110, a memory 1120, e.g., random access memory (RAM) and/or read only memory (ROM), gateway module 1140, user entity module 1150, and various input/output devices 1130, (e.g., storage devices, including but not limited to, a tape drive, a floppy drive, a hard disk drive or a compact disk drive, a receiver, a transmitter, a speaker, a microphone, a display, a camera, and other devices commonly required in multimedia, e.g., content delivery, system components, Universal Serial Bus (USB) mass storage, network attached storage, storage device on a network cloud).

It should be understood that gateway module 1140 and user entity module 1150 can be implemented as one or more physical devices that are coupled to CPU 1110 through a communication channel. Alternatively, gateway module 1140 and user entity module 1150 can be represented by one or more software applications (or even a combination of software and hardware, e.g., using application specific integrated circuits (ASIC)), where the software is loaded from a storage medium, (e.g., a magnetic or optical drive or diskette) and operated by the CPU in memory 1120 of the computer. As such, gateway module 1140 and user entity module 1150 (including associated data structures) of the present invention can be stored on a computer readable medium, e.g., RAM memory, magnetic or optical drive or diskette and the like.

Advantages of the present disclosure are as follows. 1) Mobility—Wi-Fi devices can be used anywhere in the home up to a range of at least 64 meters. 2) Flexible Endpoint—Users can use existing mobile phones to make calls over a packet-cable network. 3) Fax services can be provided over mobile phones. (User can take a picture of a document and fax the picture to a telephone number, with the help of client software). 4) Video calling services can be provided, through a camera device of a mobile phone.

While the foregoing is directed to embodiments of the present invention, other and further embodiments of the invention may be devised without departing from the basic scope thereof, and the scope thereof is determined by the claims that follow.

What is claimed is:

1. A method for providing a short range wireless protocol network packet-cable endpoint using a gateway, comprising:
receiving a request to establish a short range wireless protocol network connection between the gateway and a user entity;
receiving a client application connection request from the user entity via the short range wireless protocol network connection; and
recognizing the user entity as a packet-cable endpoint in response to the received client application connection request.

2. The method according to claim 1, wherein packet-cable traffic is sent and received via the short range wireless protocol network connection is marked for identification as packet-cable data.

3. The method according to claim 2, wherein the gateway sends an alarm trigger to the user entity in response to a detected event.

4. The method of claim 3, wherein, in response to the detected event, the gateway enables analog device ports coupled to the gateway.

5. The method according to claim 2, wherein the traffic for the connection is marked or shaped for quality of service (QoS).

6. The method according to claim 2, wherein the gateway periodically performs a status check for available user entities.

7. The method according to claim 2, wherein the gateway receives status update messages from the user entity.

8. The method according to claim 2, further comprising:
receiving a first indication of an incoming call via a packet cable network;
sending a second indication of the incoming packet-cable network call to the user entity via the short range wireless protocol network connection.

9. A method for providing a short range wireless protocol packet-cable endpoint using a user entity, comprising:
sending a request to establish a short range wireless protocol network connection between a gateway and the user entity;
sending a client application connection request to the gateway via the short range wireless protocol network connection; and
in response to being recognized by the gateway as a packet-cable endpoint, sending and receiving packet-cable data traffic via the short range wireless protocol network connection.

10. The method according to claim 9, further comprising:
receiving status check messages from the gateway.

11. The method according to claim 9, further comprising:
sending status update messages to the gateway.

12. The method according to claim 9, wherein the traffic is marked for identification as packet-cable data.

13. The method of claim 9, further comprising:
receiving an alarm trigger from the gateway in response to an event detected by the gateway.

14. The method according to claim 9, wherein traffic for the connection is marked or shaped for Quality of Service (QoS).

15. The method of claim 9, further comprising:
receiving an indication of an incoming packet-cable call from the gateway; and
based on the received indication, the client application generating an alert on the user entity.

16. The method of claim 15, further comprising answering the call in response to user input.

17. The method of claim 15, wherein the incoming packet-cable call is a video call.

18. An apparatus comprising a gateway for providing a short range wireless protocol packet-cable endpoint, comprising:
a receiver that receives a request from a user entity to establish a short range wireless protocol connection between the gateway and the user entity;
the receiver receives a client application connection request from the user entity via the short range wireless protocol connection;
a processor that recognizes the user entity as a packet-cable endpoint in response to the received client application connection request.

19. The apparatus of claim 18, wherein packet-cable traffic is sent and received via the short range wireless protocol connection is marked for identification as packet-cable data.

20. The apparatus of claim 19, wherein the receiver of the gateway receives status update messages from the user entity.

21. The apparatus of claim 20, wherein the traffic is marked for identification as packet-cable data.

22. The apparatus of claim 19, further comprising:
a transmitter that sends an alarm trigger to the user entity in response to a detected event.

23. An apparatus comprising a user entity for providing a short range wireless protocol packet-cable endpoint, comprising:
a receiver configured to detect a short range wireless protocol signal provided by a gateway;
a transmitter configured to send a request to establish a packet-cable short range wireless protocol connection between the gateway and the user entity;
the transmitter configured to send a client application connection request to the gateway via the packet-cable short range wireless protocol connection;
the transmitter and the receiver configured to respectively send and receive packet-cable data via the packet-cable short range wireless protocol connection.

24. The apparatus of claim 23, wherein the receiver is configured to receive status check messages from the gateway.

25. The apparatus according to claim 23, wherein the transmitter is configured to send status update messages to the gateway.

26. The method of claim 23, wherein the receiver is configured to receive an alarm trigger from the gateway in response to an event detected by the gateway.
